(19) United States
(12) Patent Application Publication
(10) Pub. No.: US 2025/0383501 A1
(43) Pub. Date: Dec. 18, 2025

(54) OPTICAL FIBER ALIGNMENT METHOD, OPTICAL FIBER CONNECTOR MANUFACTURING METHOD, OPTICAL FIBER ALIGNMENT DEVICE, AND OPTICAL FIBER FUSION SPLICING MACHINE

(71) Applicant: Fujikura Ltd., Tokyo (JP)

(72) Inventors: Masaki Ohzeki, Chiba (JP); Yusuke Sasaki, Chiba (JP); Katsuhiro Takenaga, Sakura-shi (JP)

(73) Assignee: Fujikura Ltd., Tokyo (JP)

(21) Appl. No.: 18/839,274

(22) PCT Filed: Jan. 22, 2023
(86) PCT No.: PCT/JP2023/001812

§ 371 Date: Feb. 13, 2025

(30) Foreign Application Priority Data
Feb. 17, 2022 (JP) 2022-022755

(51) Int. Cl. G02B 6/255

(52) U.S. Cl. CPC G02B 6/2555; G02B 6/2553

(57) ABSTRACT

An alignment device (200) includes imaging units (105A) and (105B) configured to capture side surface images of a pair of optical fibers (10A) and (10B) for one turn in a circumferential direction at a plurality of focus positions, a feature amount calculation unit (112) configured to calculate, for each of the focus positions, a feature amount obtained by digitizing features of the side surface images for one turn of each of the optical fibers (10A) and (10B), a degree of asymmetry calculation unit (113) configured to calculate, for each of the focus positions, a degree of asymmetry between the feature amounts for one turn of the respective optical fibers (10A) and (10B), a focus position selection unit (114) configured to select a specific focus position among the focus positions having a predetermined degree of asymmetry or more, and a rotation alignment unit configured to perform alignment of the pair of optical fibers (10A) and (10B) in the circumferential direction based on the side surface images for one turn of the respective optical fibers (10A) and (10B) at the selected focus position.

### TECHNICAL FIELD

The present invention relates to an optical fiber alignment method, an optical fiber connector manufacturing method, an optical fiber alignment device, and an optical fiber fusion splicing machine.

### BACKGROUND ART

In order to perform long-distance transmission of light, a pair of optical fibers may be connected to each other to be elongated, and such connection is also performed in a multicore fiber. Examples of a method of connecting optical fibers to each other include fusion splicing using a fusion splicing machine. When the multicore fibers are fusion-spliced together, it is necessary to connect cores of the multicore fibers to each other. For this reason, at least one of a pair of multicore fibers respectively having one end surfaces facing each other in a state in which the central axes coincide with each other is rotated in the circumferential direction, and alignment in the rotation direction of the multicore fibers is performed. As a multicore fiber alignment method, for example, a method described in Patent Literature 1 below is known. In the multicore fiber alignment method described in Patent Literature 1, a multicore fiber is rotated by 0.1 degrees around the axis, and an image viewed from the outer peripheral surface of the multicore fiber is acquired every rotation of 0.1 degrees. Thereafter, a rotation angle of the multicore fiber is obtained by machine learning based on the acquired image so as to perform alignment, or a correlation coefficient is obtained so as to perform alignment of the multicore fiber at a rotation angle at which the correlation coefficient is maximized.
[Patent Literature 1] JP 2019-159017 A

### SUMMARY OF INVENTION

In a multicore fiber, cores arranged on the outermost periphery may be arranged at equal intervals on the circumference having a central portion of a clad as a central portion thereof. However, the positions of the cores may be slightly shifted from each other. Even in a case where the positions of the cores are slightly shifted from each other, when the multicore fiber is imaged from the side as in the method described in Patent Literature 1, substantially the same image is obtained at each predetermined angle in each of the pair of multicore fibers. In this case, even if it is attempted to connect predetermined cores to each other in each of the multicore fibers, it is difficult to determine which image is selected from the plurality of substantially the same images in each of the multicore fibers so as to perform alignment. Therefore, it is difficult to determine in what combination the respective cores of the respective multicore fibers are made to face each other so as to be fusion-spliced together. Therefore, there is a demand for appropriate alignment in the circumferential direction. Further, in the case of a single-core fiber as well, when a core is eccentric from a central portion of a clad, there is a demand for appropriate alignment in the circumferential direction.

Therefore, an object of the present invention is to provide an optical fiber alignment method, an optical fiber connector manufacturing method, an optical fiber alignment device, and an optical fiber fusion splicing machine capable of appropriately performing alignment in the circumferential direction.

In order to achieve the above object, a first aspect of the present invention is an optical fiber alignment method including: an imaging step of capturing side surface images of a pair of optical fibers for one turn in a circumferential direction at a plurality of focus positions; a feature amount calculation step of calculating, for each of the focus positions, a feature amount for each of the optical fibers for the one turn, the feature amount being obtained by digitizing features of the side surface images; a degree of asymmetry calculation step of calculating, for each of the focus positions, a degree of asymmetry between the feature amounts for the one turn of the respective optical fibers; a focus position selection step of selecting a specific focus position among the focus positions having a predetermined degree of asymmetry or more that is larger than a smallest degree of asymmetry; and a rotation alignment step of performing alignment of the pair of optical fibers in the circumferential direction based on the side surface images for the one turn of the respective optical fibers at the selected focus position.

In such an alignment method, the selected specific focus position is a position at which the degree of asymmetry between the feature amounts for one turn based on the side surface images for one turn of each of the pair of optical fibers is equal to or greater than the predetermined degree of asymmetry larger than the smallest degree of asymmetry. For this reason, side surface images captured at the selected focus position more clearly indicate a structural difference between the respective optical fibers than side surface images captured at the focus position having degree of asymmetry smaller than the predetermined degree of asymmetry. In this way, since the focus position at which the structural difference between the respective optical fibers is clear is selected and the alignment is performed using the side surface images showing the clear structural difference, according to the optical fiber alignment method of the present invention, the alignment in the circumferential direction can be appropriately performed.

A second aspect of the present invention is the optical fiber alignment method according to the first aspect, in which the degree of asymmetry calculation step includes a cross-correlation calculation step and a difference calculation step, and when the feature amounts for the one turn include n repetitive patterns of two or more times similar to each other, in the cross-correlation calculation step, a relative angle formed between the respective optical fibers in the circumferential direction is changed for each of the focus positions, and a cross-correlation between the feature amounts for the one turn of the respective optical fibers is calculated at each relative angle, and in the difference calculation step, a difference between a plurality of peak values among nth largest peaks in the cross-correlation is calculated for each focus position, and the degree of asymmetry is obtained based on the difference.

As described above, in a case where the feature amounts for one turn include n repetitive patterns of two or more times, the respective optical fibers have refractive index profiles similar to each other in n-fold rotational symmetry in the circumferential direction having a central axis of a clad as a central portion thereof. Examples of such an optical fiber include a multicore fiber in which a plurality of cores are arranged substantially in n-fold rotational symmetry in the circumferential direction having a central axis of a clad as a central portion thereof, and an optical fiber having stress applying parts arranged so as to sandwich the cores arranged at the central portion of the clad. In the case of aligning such an optical fiber, when the relative angle formed between the optical fibers is changed and the cross-correlation between the feature amounts for one turn of the side surface images of the pair of optical fibers is calculated, large peaks as many as the plurality of repetitive patterns are calculated. That is, n large peaks are calculated. This large peak is due to the influence of the refractive index profile forming each pattern. Therefore, a deviation between the nth largest peaks, which are the same as the number of the plurality of repetitive patterns in the cross-correlation, indicates a deviation of the refractive index profile forming each of the repetitive patterns. Therefore, by calculating a difference between a plurality of peak values among the n peaks due to the influence of the refractive index profile and calculating the degree of asymmetry based on the difference therebetween, the degree of asymmetry can be easily obtained. When the degree of asymmetry is obtained, the calculated difference may be used as the degree of asymmetry as it is.

A third aspect of the present invention is the optical fiber alignment method according to the second aspect, in which, in the difference calculation step, the difference is calculated by a standard deviation or a dispersion of the plurality of peak values.

A fourth aspect of the present invention is the optical fiber alignment method according to the second aspect, in which, in the difference calculation step, the difference is calculated by a ratio or a difference between two peak values among the nth largest peak values.

A fifth aspect of the present invention is the optical fiber alignment method according to any one of the first to fourth aspects, in which, in the focus position selection step, when a standard deviation of all the degrees of asymmetry is set to σ, the focus position having the degree of asymmetry of 1+1.96σ or more is selected.

By selecting such a focus position, alignment can be appropriately performed with a probability of 95% or more statistically.

A sixth aspect of the present invention is the optical fiber alignment method according to any one of the first to fourth aspects, in which, in the focus position selection step, the focus position having the maximum degree of asymmetry is selected.

By selecting such a focus position, alignment can be appropriately performed with the highest probability.

A seventh aspect of the present invention is an optical fiber connector manufacturing method including a fusion splicing step of aligning the pair of optical fibers by the optical fiber alignment method according to any one of the first to sixth aspects and then fusion-splicing the pair of optical fibers.

According to the optical fiber connector manufacturing method, it is possible to obtain an optical fiber connector having a pair of optical fibers appropriately aligned in the circumferential direction.

Further, in order to solve the above problem, an eighth aspect of the present invention is an optical fiber alignment device including: an imaging unit configured to capture side surface images of a pair of optical fibers for one turn in a circumferential direction at a plurality of focus positions; a feature amount calculation unit configured to calculate, for each of the focus positions, a feature amount for each of the optical fibers for the one turn, the feature amount being obtained by digitizing features of the side surface images; a degree of asymmetry calculation unit configured to calculate, for each of the focus positions, a degree of asymmetry between the feature amounts for the one turn of the respective optical fibers; a focus position selection unit configured to select a specific focus position among the focus positions having a predetermined degree of asymmetry or more that is larger than a smallest degree of asymmetry; and a rotation alignment unit configured to perform alignment of the pair of optical fibers in the circumferential direction based on the side surface images for the one turn of the respective optical fibers at the selected focus position.

According to such an optical fiber alignment device, it is possible to appropriately perform alignment in the circumferential direction similarly to the first aspect.

A ninth aspect of the present invention is the optical fiber alignment device according to the eighth aspect, in which: the degree of asymmetry calculation unit includes a cross-correlation calculation unit and a difference calculation unit, and when the feature amounts for the one turn includes n repetitive patterns of two or more times similar to each other, the cross-correlation calculation unit is configured to change, for each of the focus positions, a relative angle formed between the respective optical fibers in the circumferential direction, and to calculate a cross-correlation between the feature amounts for the one turn of the respective optical fibers at each relative angle, and the difference calculation unit is configured to calculate, for each focus position, a difference between a plurality of peak values among nth largest peaks in the cross-correlation, and to obtain the degree of asymmetry based on the difference.

According to such an optical fiber alignment device, the degree of asymmetry can be easily obtained as in the second aspect.

A tenth aspect of the present invention is the optical fiber alignment device according to the ninth aspect, in which the difference calculation unit is configured to calculate the difference by a standard deviation or a dispersion of the plurality of peak values.

An eleventh aspect of the present invention is the optical fiber alignment device according to the ninth aspect, in which the difference calculation unit is configured to calculate the difference by a ratio or a difference between two peak values among the nth largest peak values.

A twelfth aspect of the present invention is the optical fiber alignment device according to any one of the eighth to eleventh aspects, in which the focus position selection unit is configured to select, when a standard deviation of all the degrees of asymmetry is set to σ, the focus position having the degree of asymmetry of 1+1.96σ or more.

In this case, similarly to the fifth aspect, the alignment can be appropriately performed with a probability of statistically 95% or more.

A thirteenth aspect of the present invention is the optical fiber alignment device according to any one of the eighth to eleventh aspects, in which the focus position selection unit is configured to select the focus position having the maximum degree of asymmetry.

In this case, similarly to the sixth aspect, the alignment can be appropriately performed with the highest probability.

A fourteenth aspect of the present invention is an optical fiber fusion splicing machine including: the optical fiber alignment device according to any one of the eighth to thirteenth aspects; and a fusion splicing unit configured to fusion-splice the pair of optical fibers aligned by the alignment device.

According to such an optical fiber fusion splicing machine, it is possible to obtain an optical fiber connector in which a pair of optical fibers is appropriately aligned in the circumferential direction.

As described above, according to the present invention, it is possible to provide an optical fiber alignment method capable of appropriately performing alignment in the circumferential direction, an optical fiber connector manufacturing method using the alignment method, an optical fiber alignment device capable of appropriately performing alignment in the circumferential direction, and an optical fiber fusion splicing machine using the alignment device.

### BRIEF DESCRIPTION OF DRAWINGS

FIG. 1 is a side view schematically illustrating an optical fiber connector according to an embodiment of the present invention.

FIG. 2 is a cross-sectional view of an optical fiber illustrated in FIG. 1.

FIG. 3 is a diagram conceptually illustrating an example of a configuration of a fusion splicing machine according to the embodiment of the present invention.

FIG. 4 is a diagram illustrating a profile of feature amounts for one turn of a pair of optical fibers when a focus position of an imaging unit is 0.71.

FIG. 5 is a diagram illustrating a profile of feature amounts for one turn of a pair of optical fibers when the focus position of the imaging unit is 0.56.

FIG. 6 is a diagram illustrating a profile of a relationship between a relative angle formed between the pair of optical fibers at the focus position of 0.71 in the imaging unit and a cross-correlation between feature amounts for one turn of the pair of optical fibers.

FIG. 7 is a diagram illustrating a profile of a relationship between a relative angle formed between the pair of optical fibers at the focus position of 0.56 in the imaging unit and a cross-correlation between feature amounts for one turn of the pair of optical fibers.

FIG. 8 is a diagram illustrating a relationship between a focus position and a degree of asymmetry.

FIG. 9 is a flowchart illustrating steps of an optical fiber connector manufacturing method.

FIG. 10 is a diagram illustrating a relationship between a focus position and a ratio of peak values by a combination of two peaks.

FIG. 11 is a diagram illustrating a relationship between a focus position and a difference between peak values by a combination of two peaks.

FIG. 12 is a diagram illustrating a relationship between a focus position and a standard deviation of all peak values.

### DESCRIPTION OF EMBODIMENTS

Hereinafter, an optical fiber alignment method, an optical fiber connector manufacturing method, an optical fiber alignment device, and an optical fiber fusion splicing machine according to the present invention will be described with the accompanying drawings. The embodiments exemplified below are intended to facilitate understanding of the present invention and are not intended to limit the present invention. The present invention can be modified and improved from the following embodiments without departing from the gist thereof. In addition, in the present specification, dimensions of each member may be exaggerated for easy understanding.

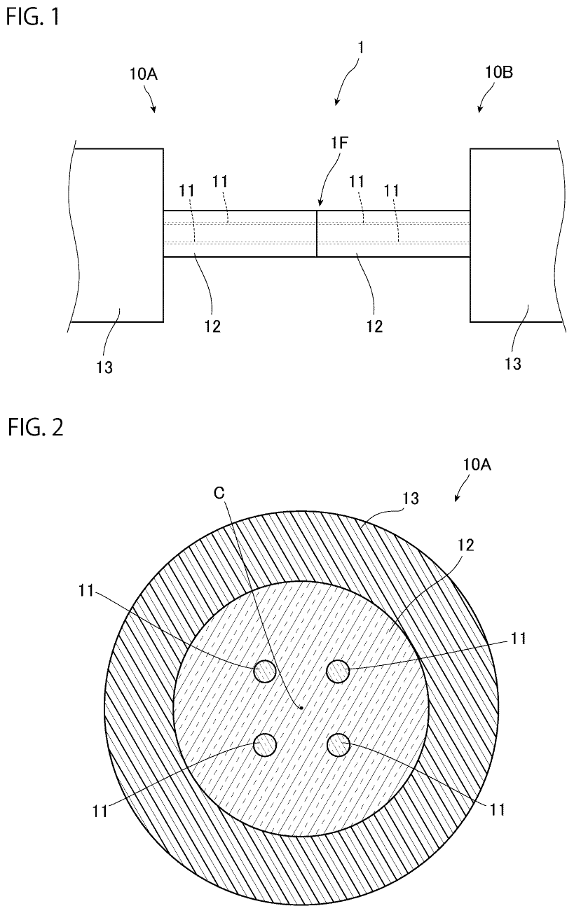

FIG. 1 is a side view schematically illustrating an optical fiber connector according to an embodiment. In the present embodiment, an example in which an optical fiber is a multicore fiber will be described. As illustrated in FIG. 1, an optical fiber connector 1 includes an optical fiber 10A located on one side thereof, an optical fiber 10B located on the other side thereof, and a connection portion 1F at which one end portion of the optical fiber 10A and one end portion of the optical fiber 10B are fusion-spliced together. The configurations of the optical fibers 10A and 10B are substantially the same. Therefore, the configurations of the optical fibers 10A and 10B will be described with reference to the drawing of the optical fiber 10A.

FIG. 2 is a cross-sectional view of the optical fiber 10A illustrated in FIG. 1. As illustrated in FIG. 2, the optical fiber 10A according to the present embodiment includes a plurality of cores 11, a clad 12, and a coating layer 13 coating the clad 12.

As illustrated in FIG. 1, in each of the optical fibers 10A and 10B, the coating layer 13 is peeled off over a certain distance from one end portion serving as the connection portion 1F, and the clad 12 is exposed. The coating layer 13 is made of, for example, an ultraviolet curable resin.

In the optical fiber 10A of the present embodiment, the respective cores 11 are arranged at substantially equal intervals on the circumference having a central axis C of the clad 12 as a central portion thereof. It is noted that, in the present embodiment, the four cores 11 are arranged at equal intervals. Each of the cores 11 is formed to have substantially the same diameter and substantially the same refractive index, and only propagates light of a fundamental mode or propagates light of some higher modes in addition to the light of the fundamental mode. The refractive index of each core 11 is higher than the refractive index of the clad 12.

In the optical fiber connector 1 of the present embodiment, the central axes C of the clads 12 coincide with each other so that the cores 11 of the optical fibers 10A and 10B are optically coupled to each other, and one end portions of the optical fibers 10A and 10B are fusion-spliced together in a state in which the relative positions in the rotation direction are aligned with each other. Therefore, as illustrated in FIG. 1, the core 11 of the optical fiber 10A and the core 11 of the optical fiber 10B are individually fusion-spliced together.

Next, a fusion splicing machine of the optical fibers 10A and 10B capable of manufacturing such an optical fiber connector 1 will be described.

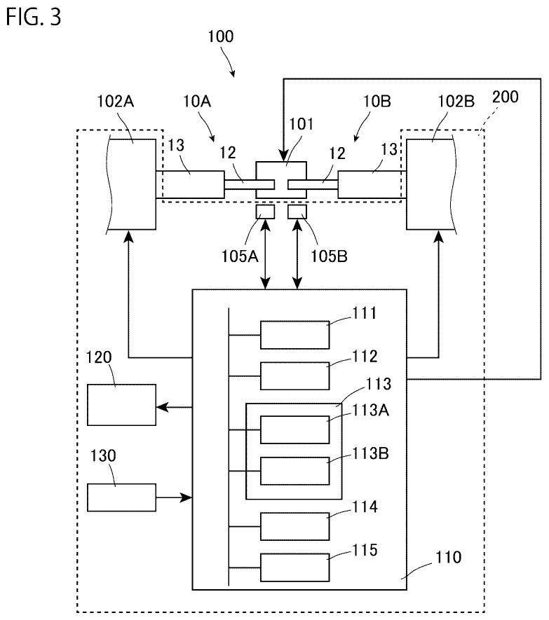

FIG. 3 is a diagram conceptually illustrating a configuration of a fusion splicing machine 100 of the present embodiment. As illustrated in FIG. 3, the fusion splicing machine 100 mainly includes an alignment device 200 of the optical fibers 10A and 10B and a fusion splicing unit 101. The alignment device 200 mainly includes rotation units 102A and 102B, imaging units 105A and 105B, a processing unit 110, a memory 120, and an input unit 130. The processing unit 110 mainly includes an image processing unit 111, a feature amount calculation unit 112, a degree of asymmetry calculation unit 113, a focus position selection unit 114, and a control unit 115. In the present embodiment, the degree of asymmetry calculation unit 113 includes a cross-correlation calculation unit 113A and a difference calculation unit 113B. It is noted that FIG. 3 illustrates an example in which the respective units in the processing unit 110 are connected to each other by a bus line.

The rotation unit 102A rotatably holds the optical fiber 10A around the central axis C, and the rotation unit 102B rotatably holds the optical fiber 10B around the central axis C. In addition, the rotation units 102A and 102B are configured to be movable in a direction perpendicular to a direction of the central axis C, and the central axes C of the optical fibers 10A and 10B are aligned with each other so that one end surfaces of the optical fibers 10A and 10B can face each other. It is noted that the rotation units 102A and 102B each rotate by, for example, a stepping motor or the like, and can stop at a desired rotation angle. Furthermore, the rotation units 102A and 102B are electrically connected to the processing unit 110, and can be rotated at the rotation angle based on a signal from the control unit 115 of the processing unit 110.

The fusion splicing unit 101 fusion-splices an end portion of the optical fiber 10A held by the rotation unit 102A and an end portion of the optical fiber 10B held by the rotation unit 102B. The fusion splicing unit 101 includes, for example, a pair of discharge electrodes facing each other with the end portions of the optical fibers 10A and 10B interposed therebetween, and the optical fibers 10A and 10B are fusion-spliced by heating due to discharge from the discharge electrodes. The fusion splicing unit 101 is electrically connected to the processing unit 110, and a discharge timing, a discharge intensity, and the like are adjusted by a signal from the control unit 115 of the processing unit 110.

The imaging unit 105A is arranged to substantially directly face the side surface at one end portion of the optical fiber 10A, and can capture a side surface image of the optical fiber 10A from a direction perpendicular to the longitudinal direction of the optical fiber 10A. The imaging unit 105B is arranged to substantially directly face the side surface at one end portion of the optical fiber 10B, and can capture a side surface image of the optical fiber 10B from a direction perpendicular to the longitudinal direction of the optical fiber 10B. As described above, the coating layer 13 is peeled off at the one end portion of each of the optical fibers 10A and 10B. Therefore, the imaging unit 105A can capture an image of the side surface of the clad 12 of the optical fiber 10A and an image of a part of the core 11 that can be visually recognized through the clad 12, and the imaging unit 105B can capture an image of the side surface of the clad 12 of the optical fiber 10B and an image of at least a part of the core 11 that can be visually recognized through the clad 12. Each of the imaging units 105A and 105B is electrically connected to the processing unit 110. The imaging units 105A and 105B can capture images at any timing by a signal from the control unit 115 of the processing unit 110. For example, imaging can be performed every time the rotation units 102A and 102B rotate the optical fibers 10A and 10B at a desired rotation angle. The desired rotation angle is, for example, 0.1 degrees. The imaging units 105A and 105B input the captured images to the image processing unit 111 of the processing unit 110.

Furthermore, each of the imaging units 105A and 105B of the present embodiment includes a fixed focus type camera, the focus position of which is fixed at a predetermined distance from the imaging units 105A and 105B, and are configured to be movable in the imaging direction of the imaging units 105A and 105B. Therefore, the imaging units 105A and 105B can image the optical fibers 10A and 10B at a plurality of focus positions by moving relative to the optical fibers 10A and 10B. The focus position is a focus position in the radial direction of the optical fibers 10A and 10B in the imaging direction of the imaging units 105A and 105B. It is noted that, in a case where each of the imaging units 105A and 105B includes a focus adjustment function capable of adjusting the focus position, the imaging units 105A and 105B may image the optical fibers 10A and 10B at a plurality of focus positions by using the function. The focus position is preferably adjusted by the control unit 115 to be described later. That is, in a case where each of the imaging units 105A and 105B includes the fixed focus type camera, the imaging units 105A and 105B are moved in the radial direction of the optical fibers 10A and 10B by a moving unit (not illustrated) in response to a control signal from the control unit 115, so that a desired focus position is obtained. Furthermore, in a case where each of the imaging units 105A and 105B includes the focus adjustment function, each of the imaging units 105A and 105B adjusts a focus in response to a control signal from the control unit 115, so that a desired focus position is obtained. The imaging unit 105A and the imaging unit 105B may be integrated so that one end portion of each of the pair of optical fibers 10A and 10B can be simultaneously imaged, or the focus position of the imaging unit 105A relative to the optical fiber 10A and the focus position of the imaging unit 105B relative to the optical fiber 10B may be configured to be similar.

The processing unit 110 can use, for example, an integrated circuit such as a microcontroller, an integrated circuit (IC), a large-scale integrated circuit (LSI), or an application specific integrated circuit (ASIC), or a numerical control (NC) device. Furthermore, in a case where the NC device is used, the processing unit 110 may use a machine learning device or may not use a machine learning device. The control unit 115 of the processing unit 110 controls operations of the fusion splicing unit 101, the rotation units 102A and 102B, the imaging units 105A and 105B, the image processing unit 111, the feature amount calculation unit 112, the cross-correlation calculation unit 113A, the difference calculation unit 113B, the focus position selection unit 114, and the like.

The memory 120 is electrically connected to the processing unit 110. The memory 120 is, for example, a non-transitory recording medium, and is preferably a semiconductor recording medium such as a random access memory (RAM) or a read only memory (ROM), but can include a recording medium of any known format such as an optical recording medium or a magnetic recording medium. It is noted that the “non-transitory” recording medium includes all computer-readable recording media except for a transitory propagating signal (transitory, propagating signal), and does not exclude a volatile recording medium.

The image processing unit 111 processes image signals respectively input from the imaging units 105A and 105B. At this time, for example, noise may be removed from the image, or a signal indicating each pixel of the image may be binarized. The signal processed by the image processing unit 111 is output from the image processing unit 111 and is input to the feature amount calculation unit 112. It is noted that, in a case where image processing is unnecessary, the image processing unit 111 is unnecessary, and in this case, the image signals output from the imaging units 105A and 105B may be directly input to the feature amount calculation unit 112.

The feature amount calculation unit 112 calculates, for the respective optical fibers 10A and 10B, feature amounts obtained by digitizing features of the respective side surface images captured by the imaging units 105A and 105B. Therefore, in a case where the imaging units 105A and 105B capture the side surface images of the optical fibers 10A and 10B for one turn, the feature amount calculation unit 112 calculates the feature amounts for one turn of the optical fibers 10A and 10B. For example, in a case where the imaging units 105A and 105B image the optical fibers 10A and 10B each time the rotation units 102A and 102B rotate the optical fibers 10A and 10B at a rotation angle of 0.1 degrees, the feature amount calculation unit 112 calculates 3600 feature amounts for the respective optical fibers 10A and 10B. Therefore, the feature amounts for one turn includes, for the respective optical fibers 10A and 10B, for example, data of a combination of the rotation angle of the optical fiber and the feature amount at the rotation angle. A method of calculating the feature amount of the side surface image is not particularly limited as long as the feature of the side surface image can be digitized, but for example, processing such as edge detection and region extraction is performed using a luminance distribution of the side surface image, a local feature amount and a global feature amount are calculated from a geometric feature such as a width, an area, and a metering tensor of each region, an analysis feature such as a luminance gradient, the Laplacian, and the Fourier coefficient, and the like, and these feature amounts are appropriately combined and obtained. Machine learning may be used to calculate the feature amount. In the present embodiment, as will be described later, under the control of the control unit 115, the imaging units 105A and 105B capture the side surface images of the optical fibers 10A and 10B for one turn in the circumferential direction at a plurality of focus positions, so that the feature amount calculation unit 112 calculates the feature amounts for one turn of the optical fibers 10A and 10B at the respective focus positions.

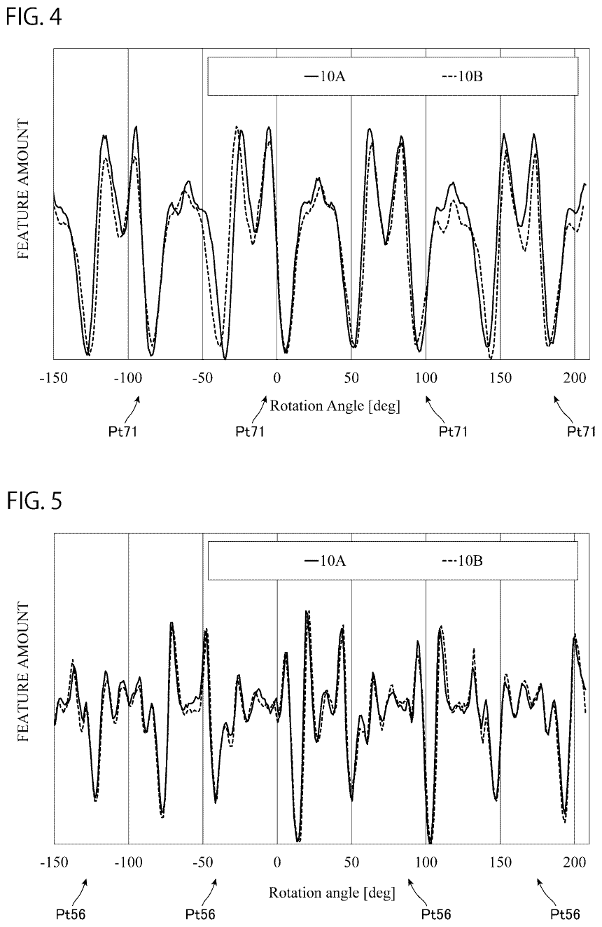

FIG. 4 is a diagram illustrating a profile of the feature amounts for one turn of the optical fibers 10A and 10B when the focus positions of the imaging units 105A and 105B are 0.71. The focus position of 0.71 means that a relative value obtained by dividing the coordinates of the focus position by the coordinates of a certain standard focus position is 0.71. Hereinafter, this profile may be referred to as a feature amount profile. In the present embodiment, as described above, in the optical fibers 10A and 10B, the four cores 11 are arranged at substantially equal intervals on the circumference having the central axis C of the clad 12 as a central portion thereof.

Therefore, the optical fiber 10A has refractive index profiles similar to each other in four-fold rotational symmetry in the circumferential direction having the central axis C of the clad 12 as a central portion thereof, and the optical fiber 10B has refractive index profiles similar to each other in four-fold rotational symmetry in the circumferential direction having the central axis C of the clad 12 as a central portion thereof. Therefore, as illustrated in FIG. 4, the feature amount profile of the optical fiber 10A indicated by a solid line includes four repetitive patterns similar to each other, and the feature amount profile of the optical fiber 10B indicated by a broken line also includes four repetitive patterns similar to each other. It is noted that it is important that the feature amount profile includes repetitive patterns similar to each other, and it is not necessary to define a boundary of this pattern. In FIG. 4, one of the repetitive patterns is indicated by Pt71.

FIG. 5 is a diagram illustrating the feature amount profile for one turn of the optical fibers 10A and 10B at the focus position of 0.56 in the imaging units 105A and 105B. As illustrated in FIG. 5, the feature amount profile of the optical fiber 10A and the feature amount profile of the optical fiber 10B include four repetitive patterns similar to each other. In FIG. 5, one of the repetitive patterns is indicated by Pt56. As is clear from FIGS. 4 and 5, when the focus positions of the imaging units 105A and 105B are different from each other, the feature amount changes and the feature amount profile also changes. It is noted that, even if the feature amount for one turn is not visualized, as illustrated in FIGS. 4 and 5, the feature amount calculation unit 112 can grasp this repetitive pattern. For this grasping, a technique such as pattern recognition is used, and machine learning may be used as the technique.

In the present embodiment, an example in which the repetitive pattern is repeated four times is illustrated. However, in a case where the optical fibers 10A and 10B have refractive index profiles similar to each other in n-fold rotational symmetry two or more times in the circumferential direction having the central axis C of the clad 12 as a central portion thereof, the feature amount profile for one turn includes the repetitive pattern n times. A signal indicating the feature amount for one turn of each of the optical fibers 10A and 10B calculated by the feature amount calculation unit 112 in this manner is stored in the memory 120.

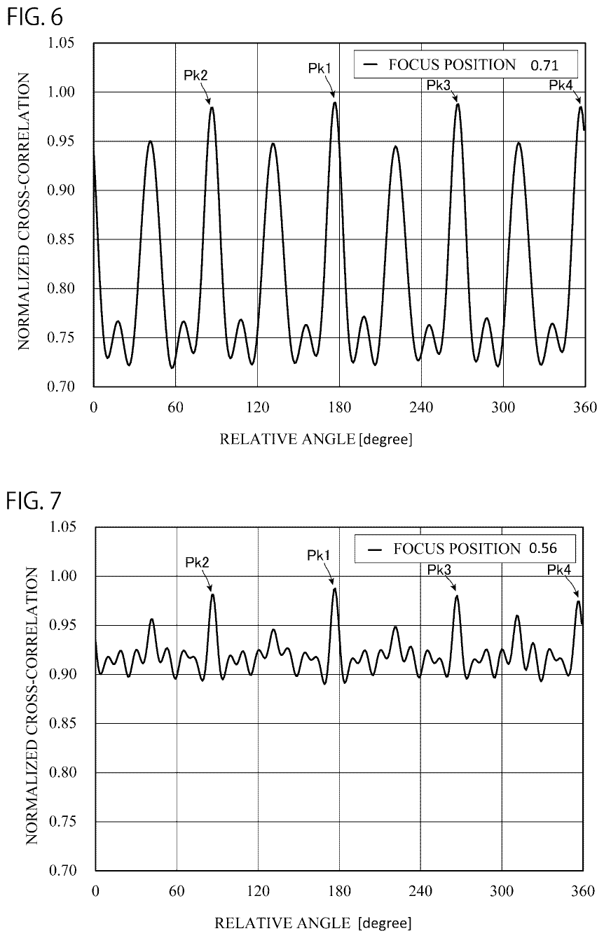

The cross-correlation calculation unit 113A changes the relative angle formed between the optical fibers 10A and 10B in the circumferential direction, and calculates a cross-correlation between the feature amounts for one turn of the respective optical fibers at each relative angle. The cross-correlation calculation unit 113A changes the relative angle of the feature amounts for one turn of the optical fibers 10A and 10B on the data. Specifically, for example, the cross-correlation calculation unit 113A calculates the cross-correlation between the feature amounts for one turn of the optical fibers 10A and 10B at each relative angle while shifting the relative angle of the feature amounts for one turn of the optical fibers 10A and 10B by 0.1 degrees. The cross-correlation is obtained by, for example, a cross-correlation function. As the cross-correlation is closer to 1, the cross-correlation between the feature amounts for one turn of the optical fibers 10A and 10B is higher, and as the cross-correlation is closer to 0, the cross-correlation between the feature amounts for one turn of the optical fibers 10A and 10B is lower. FIG. 6 is a diagram illustrating a profile of a relationship between a relative angle formed between the optical fibers 10A and 10B when the focus positions of the imaging units 105A and 105B are 0.71 and a cross-correlation between feature amounts for one turn of the optical fibers 10A and 10B. This relationship includes data of a combination of the relative angle formed between the optical fibers 10A and 10B in the circumferential direction and the feature amount at the relative angle. It is noted that, in FIG. 6, the cross-correlation is normalized. In addition, the relative angle formed between the optical fibers 10A and 10B is also a relative angle on data between the feature amount for one turn of the optical fiber 10A and the feature amount for one turn of the optical fiber 10B. Hereinafter, this profile may be referred to as a cross-correlation profile.

As illustrated in FIG. 6, four large peaks Pk1 to Pk4 appear in the profile of the cross-correlation. The reason for this will be described as follow. FIGS. 4 and 5 illustrate a state in which the cross-correlation between the feature amount for one turn of the optical fiber 10A and the feature amount for one turn of the optical fiber 10B is high. Therefore, when the relative angle formed between the optical fibers 10A and 10B is shifted, the cross-correlation becomes small. However, as described above, since each of the feature amounts for one turn of the optical fibers 10A and 10B includes the four repetitive patterns similar to each other, when the relative angle of the feature amounts for one turn of the optical fibers 10A and 10B changes by one turn, a state of high cross-correlation appears four times as described above. Therefore, in a case where the optical fibers 10A and 10B have refractive index profiles similar to each other in n-fold rotational symmetry two or more times in the circumferential direction having the central axis C of the clad 12 as a central portion thereof, when the relative angle formed between the optical fibers 10A and 10B changes by one turn, a state of high cross-correlation appears n times. The cross-correlation calculation unit 113A calculates a cross-correlation between the feature amounts for one turn of the optical fibers 10A and 10B at the respective focus position of the imaging units 105A and 105B.

FIG. 7 is a diagram illustrating a cross-correlation profile when the focus positions of the imaging units 105A and 105B are 0.56. It is noted that, also in FIG. 7, the cross-correlation is normalized. When the focus position changes, the feature amounts of the optical fibers 10A and 10B change as illustrated in FIGS. 4 and 5, so that the cross-correlation also changes, as illustrated in FIGS. 6 and 7. As illustrated in FIGS. 6 and 7, it can be seen that the optical fibers 10A and 10B captured at the focus position of 0.56 have a smaller change in cross-correlation than the optical fibers 10A and 10B captured at the focus position of 0.71. However, in the present embodiment, the magnitude of the change in the cross-correlation is not used for alignment of the optical fibers 10A and 10B in the rotation direction. A signal indicating a relationship between the calculated relative angle and the cross-correlation of the profile is stored in the memory 120.

The difference calculation unit 113B calculates, for each focus position, a difference between a plurality of peak values among the nth largest peaks in the cross-correlation, and obtains a degree of asymmetry between a feature amount for one turn of the optical fiber 10A and a feature amount for one turn of the optical fiber 10B based on the difference. The degree of asymmetry is an amount indicating a degree of difference between the two amounts. Here, the degree of asymmetry is an amount indicating a degree of difference between the feature amount for one turn of the optical fiber 10A and the feature amount for one turn of the optical fiber 10B in a state in which the optical fiber 10A and the optical fiber 10B form a predetermined relative angle. In the present embodiment, the first and second largest peaks Pk1 and Pk2 are used, a difference between the two peaks Pk1 and Pk2 is calculated by a ratio represented by (a value of the first largest peak Pk1)/(a value of the second largest peak Pk2), and a calculated difference is set as a degree of asymmetry. In this case, as the calculated ratio is larger, the degree of asymmetry of the optical fibers 10A and 10B is indicated more clearly. The reason for this will be described as follow. In a state in which the cross-correlation is high, that is, in a state in which the peaks Pk1 to Pk4 appear, the feature amount profile of the optical fiber 10A and the feature amount profile of the optical fiber 10B substantially coincide with each other. Therefore, the ratio is a value obtained by comparing a state in which the optical fibers 10A and 10B face each other at the most appropriate alignment angle with a state in which the optical fibers 10A and 10B face each other at the second appropriate alignment angle. Therefore, as this value is larger, a slight difference between a structure of the optical fiber 10A and a structure of the optical fiber 10B in each state is more clearly indicated.

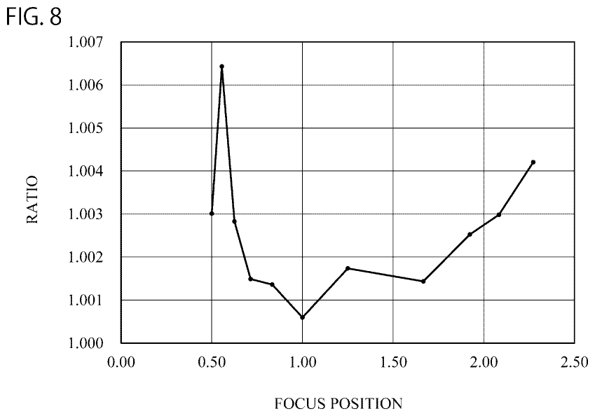

Since the cross-correlation between the feature amounts for one turn of the optical fibers 10A and 10B with the changed relative angle formed between the optical fibers 10A and 10B is calculated for each focus position, the degree of asymmetry represented by the ratio is also calculated for each focus position. FIG. 8 is a diagram illustrating a relationship between the focus position and the degree of asymmetry. As illustrated in FIG. 8, it can be seen that the degree of asymmetry calculated by the focus position changes. That is, it can be seen that a degree of indication of the slight difference between the structure of the optical fiber 10A and the structure of the optical fiber 10B changes depending on the focus position. The calculated degree of asymmetry is stored in the memory 120.

The focus position selection unit 114 selects a specific focus position among the focus positions having a predetermined degree of asymmetry or more. For example, in a case where a standard deviation of all the degrees of asymmetry is σ, the focus position selection unit 114 may select one of the focus positions at which the degree of asymmetry is 1+1.96σ or more. In this case, alignment of the optical fibers 10A and 10B to be described later can be set to an appropriate state with a probability of approximately 95% or more. In addition, in the example of FIG. 8, in a state in which the focus position is 0.56, a slight difference between the structure of the optical fiber 10A and the structure of the optical fiber 10B is most clearly illustrated. Therefore, in the example of FIG. 8, when alignment of the optical fibers 10A and 10B to be described later is set to an appropriate state with the highest probability, the focus position selection unit 114 selects the focus position of 0.56.

The input unit 130 includes an input device such as a touch panel, and is electrically connected to the processing unit 110. In the input unit 130, n is input, for example, when it is known that the optical fibers 10A and 10B have refractive index profiles similar to each other in n-fold rotational symmetry in the circumferential direction having the central axis C of the clad 12 as a central portion thereof. It is noted that the feature amount calculation unit 112 may obtain n from the feature amounts for one turn of the optical fibers 10A and 10B.

Next, a manufacturing method of the optical fiber connector 1 will be described.

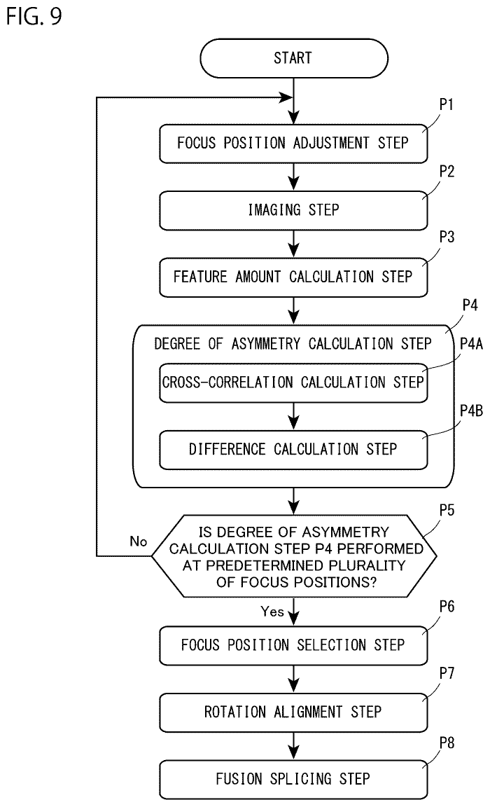

FIG. 9 is a flowchart illustrating steps of a manufacturing method of the optical fiber connector 1. As illustrated in FIG. 9, the manufacturing method of the optical fiber connector 1 includes, as main steps, a focus position adjustment step P1, an imaging step P2, a feature amount calculation step P3, a degree of asymmetry calculation step P4, a determination step P5, a focus position selection step P6, a rotation alignment step P7, and a fusion splicing step P8. The degree of asymmetry calculation step P4 includes a cross-correlation calculation step P4A and a difference calculation step P4B.

In the present embodiment, a description will be given on the assumption that the optical fiber 10A is arranged in the rotation unit 102A, the optical fiber 10B is arranged in the rotation unit 102B, and the end surfaces of the optical fibers 10A and 10B face each other so that the central axes C of the optical fibers 10A and 10B coincide with each other in the start state.

### (Focus Position Adjustment Step P1)

This step is a step in which the imaging units 105A and 105B adjust a focus position. In this step, first, the control unit 115 transmits a control signal for adjusting the focus position to the imaging units 105A and 105B. In a case where each of the imaging units 105A and 105B includes a fixed focus type camera as described above, the imaging units 105A and 105B move in the imaging directions of the imaging units 105A and 105B and stop at desired positions by driving of a moving unit (not illustrated) by the control signal. In this way, a distance between the imaging unit 105A and the optical fiber 10A and a distance between the imaging unit 105B and the optical fiber 10B are adjusted, and the respective focus positions for the optical fibers 10A and 10B in the radial direction along the imaging direction of the imaging units 105A and 105B are adjusted. In addition, in a case where each of the imaging units 105A and 105B includes a focus adjustment function, the imaging units 105A and 105B respectively adjust focus positions thereof in a direction perpendicular to the longitudinal direction of the optical fibers 10A and 10B by the control signal, and stop at respective desired positions. In this way, the focus positions in the radial direction of the optical fibers 10A and 10B are adjusted, respectively.

### (Imaging Step P2)

This step is a step of imaging the side surface images of the pair of optical fibers 10A and 10B for one turn in the circumferential direction. In this step, the control unit 115 transmits the control signal to the rotation unit 102A and 102B to rotate the optical fibers 10A and 10B around the central axis C by a predetermined rotation angle. As described above, the predetermined rotation angle is, for example, 0.1 degrees. In addition, every time the optical fibers 10A and 10B are rotated at the predetermined rotation angle, the control unit 115 transmits an imaging control signal to the imaging units 105A and 105B, and the imaging units 105A and 105B capture side surface images of the optical fibers 10A and 10B. In this way, the control unit 115 causes the imaging units 105A and 105B to capture the images of the optical fibers 10A and 10B for one turn in the circumferential direction of the optical fibers 10A and 10B. Therefore, when the predetermined rotation angle is 0.1 degrees as described above, the imaging units 105A and 105B each capture 3600 side surface images. The captured image is input to the image processing unit 111, and the control unit 115 controls the image processing unit 111 to cause the image processing unit 111 to perform predetermined image processing. The image processing unit 111 outputs image data subjected to the image processing, and the control unit 115 stores the image data in the memory 120.

### (Feature Amount Calculation Step P3)

This step is a step of calculating a feature amount obtained by digitizing features of the respectively captured side surface images. In this section, first, the feature amount calculation unit 112 reads pieces of data of the respective side surface images of the optical fibers 10A and 10B stored in the imaging step P2 from the memory 120. The feature amounts of the respective side surface images are calculated from the pieces of data of the side surface images. In the imaging step P2, since the side surface images for one turn are captured for the optical fibers 10A and 10B, the feature amounts are calculated for the pieces of data of the respective side surface images, and in this step, the feature amounts are calculated for one turn for the optical fibers 10A and 10B. When a calculated result is plotted for each rotation angle, the feature amount profile illustrated in FIGS. 4 and 5 is obtained. The feature amount calculation unit 112 outputs data indicating the feature amounts for one turn of the optical fibers 10A and 10B, and the control unit 115 stores the data in the memory 120.

### (Cross-Correlation Calculation Step P4A)

This step is a step of changing the relative angle formed between the optical fibers 10A and 10B in the circumferential direction and calculating the cross-correlation between the feature amounts of the optical fibers 10A and 10B for one turn at the respective relative angles. In this step, first, the cross-correlation calculation unit 113A reads the data indicating the feature amounts for one turn of the optical fibers 10A and 10B stored in the memory 120. Next, the cross-correlation calculation unit 113A calculates the cross-correlation between the feature amounts for one turn of the optical fibers 10A and 10B in a state in which the optical fibers 10A and 10B form a specific relative angle. Next, the cross-correlation calculation unit 113A changes the relative angle of the feature amounts for one turn of the optical fibers 10A and 10B by a predetermined angle, and calculates the cross-correlation between the feature amounts for one turn of the optical fibers 10A and 10B at the relative angle in the changed state. The relative angle changed at this time is preferably the same as the rotation angle of the optical fibers 10A and 10B rotated every time the imaging units 105A and 105B capture one side surface image in the imaging step P2 from a viewpoint of being able to use the captured image data without omission. In this case, if the rotation angle is 0.1 degrees, the cross-correlation of 3600 is calculated. When the cross-correlation is plotted for each relative angle, the cross-correlation profile illustrated in FIGS. 6 and 7 is obtained. The cross-correlation calculation unit 113A outputs data indicating the cross-correlation between the feature amounts for one turn of the optical fibers 10A and 10B at each relative angle formed between the optical fibers 10A and 10B calculated in this manner, and the control unit 115 stores the data in the memory 120.

### (Difference Calculation Step P4B)

This step is a step of calculating a difference between a plurality of peak values among nth largest peaks in the cross-correlation and obtaining a degree of asymmetry based on the difference. As described above, n is the number of times of repetition of the refractive index profiles similar to each other in a rotationally symmetric manner in the circumferential direction having the central axis C of the clad 12 in each of the optical fibers 10A and 10B as a central portion thereof. In the present embodiment, n is 4 as illustrated in FIG. 2, and four large peaks Pk1 to Pk4 appear in the feature amount profile as described above. In this step, the difference calculation unit 113B reads the data that is stored in the memory 120 and indicates the cross-correlation between the feature amounts for one turn of the optical fibers 10A and 10B at each relative angle formed between the optical fibers 10A and 10B. Next, the difference calculation unit 113B calculates a difference between the plurality of peak values among the nth largest peaks in the cross-correlation, and calculates a degree of asymmetry based on the difference therebetween. As described above, in the present embodiment, the difference calculation unit 113B calculates (a value of the first largest peak Pk1)/(a value of the second largest peak Pk2), which is a ratio of the values of the first and second largest peaks Pk1 and Pk2, as the degree of asymmetry, and outputs data indicating the calculated degree of asymmetry. The control unit 115 stores the data in the memory 120.

### (Determination Step P5)

This step is a step of determining whether the degree of asymmetry calculation step P4 has been performed at a plurality of predetermined focus positions. In this step, the control unit 115 proceeds to the focus position selection step P6 if the degree of asymmetry calculation step P4 is completed at the plurality of predetermined focus positions, and returns to the focus position adjustment step P1 if the degree of asymmetry calculation step P4 is not completed at the plurality of predetermined focus positions. In the second and subsequent focus position adjustment steps P1, the control unit 115 controls the imaging units 105A and 105B so that the focus positions of the imaging units 105A and 105B become focus positions different the focus position when the imaging step P2 is performed so far. When the step proceeds to the focus position selection step P6, the degree of asymmetry calculation step P4 is completed from the imaging step P2 at the plurality of predetermined focus positions. It is noted that the plurality of predetermined focus positions may be stored in the memory 120 in advance, or may be input from the input unit 130 and stored in the memory 120.

In order to proceed to the focus position selection step P6, it is sufficient that the degree of asymmetry calculation step P4 is completed at a plurality of predetermined focus positions, and the difference calculation step P4B does not need to be sequentially performed from the imaging step P2 for each focus position. For example, a part of the feature amount calculation step P3 may be performed while the imaging step P2 is performed, and after the imaging step P2 is completed at all the focus positions, the difference calculation step P4B may be performed from the feature amount calculation step P3 at each focus position.

### (Focus Position Selection Step P6)

This step is a step of selecting a specific focus position among the focus positions having a predetermined degree of asymmetry or more. In this step, first, the control unit 115 reads a degree of asymmetry at the plurality of focus positions stored in the memory 120. When the read degree of asymmetry is arranged for each focus position, the degrees of asymmetry are arranged as illustrated in FIG. 8 in the present embodiment. A predetermined degree of asymmetry is greater than the smallest degree of asymmetry. In this case, the focus position selection unit 114 preferably uses a standard deviation σ of all the degrees of asymmetry so as to select a focus position having a degree of asymmetry of 1+1.96σ or more from a viewpoint of being able to appropriately perform alignment with a probability of 95% or more statistically. In the case of FIG. 8, since σ is 0.0027, 1+1.96σ is 1.0053. In this case, the degree of asymmetry is 1+1.96σ or more only when the focus position is 0.56. Therefore, the focus position selection unit 114 selects the focus position of 0.56 and outputs data indicating the selected focus position. Although the selection of the focus position is not limited to this example, it is preferable to select the focus position having the largest degree of asymmetry from a viewpoint of appropriately performing alignment with the highest probability. The control unit 115 stores the data in the memory 120. It is noted that the focus position selection unit 114 may set different focus positions of the imaging unit 105A and the imaging unit 105B among the focus positions having a predetermined degree of asymmetry or more as specific focus positions.

### (Rotation Alignment Step P7)

This step is a step of aligning the optical fibers 10A and 10B in the circumferential direction by relatively rotating the optical fibers 10A and 10B around the central axis C. In this step, the control unit 115 selects a relative angle formed between the optical fiber 10A and the optical fiber 10B at the peak Pk1 at which the cross-correlation is the largest value at the focus position selected in the focus position selection step P6. Next, the control unit 115 controls the rotation units 102A and 102B so that the optical fiber 10A and the optical fiber 10B form the selected relative angle. In this way, the optical fiber 10A and the optical fiber 10B are aligned with each other. This step is performed by the control unit 115 and the rotation units 102A and 102B. That is, in the present embodiment, each of the control unit 115 and the rotation units 102A and 102B can be understood as a rotation alignment unit that aligns the optical fibers 10A and 10B in the circumferential direction. It is noted that, unlike the above description, in this step, the imaging units 105A and 105B may be caused to capture the side surface images of the optical fibers 10A and 10B again at the focus position selected in the focus position selection step P6, and rotation alignment of the optical fibers 10A and 10B may be performed based on the side surface images.

### (Fusion Splicing Step P8)

This step is a step of fusion-splicing the pair of optical fibers 10A and 10B after aligning the pair of optical fibers 10A and 10B by the above step. In this step, the control unit 115 sends a control signal to the fusion splicing unit 101 so as to allow the fusion splicing unit 101 to fusion-splice one end portion of the optical fiber 10A and one end portion of the optical fiber 10B. As described above, in a case where the fusion splicing unit 101 includes a pair of electrodes, the control unit 115 controls a power supply circuit (not illustrated) to discharge electricity from the pair of electrodes, and performs fusion splicing by heat generated by the discharge.

In this manner, the optical fiber connector 1 illustrated in FIG. 1 is manufactured.

Next, a modification of the difference calculation step P4B will be described.

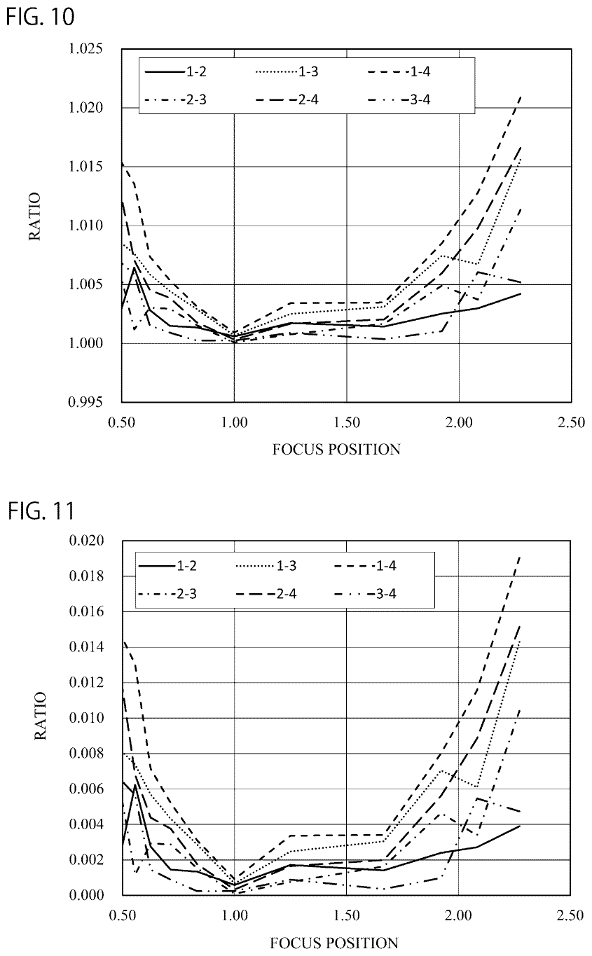

In the above embodiment, a difference between peak values is calculated from a ratio of a value of the first largest peak Pk1 to a value of the second largest peak Pk2, and a degree of asymmetry is obtained based on the difference therebetween. However, the peak used to obtain the ratio as the difference is not limited to the first largest peak Pk1 and the second largest peak Pk2. FIG. 10 is a diagram illustrating a relationship between a focus position and a ratio of peak values by a combination of two peaks. As illustrated in FIG. 10, a ratio of a value of the first largest peak Pk1 to a value of the second largest peak Pk2 and a ratio of peak values by a combination of other peaks tend to have substantially the same change with respect to the focus position. That is, in a case where a difference between two peak values is calculated using a ratio of the two peak values among the nth largest peak values in the cross-correlation, almost the same tendency is obtained for any combination of peak values. Therefore, the degree of asymmetry can be appropriately obtained by the ratio of any combination of two peak values.

FIG. 11 is a diagram illustrating a relationship between a focus position and a difference between peak values by a combination of two peaks. As illustrated in FIGS. 10 and 11, a change with respect to the focus position tends to be substantially the same between the ratio of the peak values by the combination of the two peaks illustrated in FIG. 10 to the difference between the peak values by the combination of the two peaks illustrated in FIG. 11. Therefore, even if the difference between the two peak values is calculated using the difference between the two peak values among the nth largest peak values in the cross-correlation, the degree of asymmetry can be appropriately obtained.

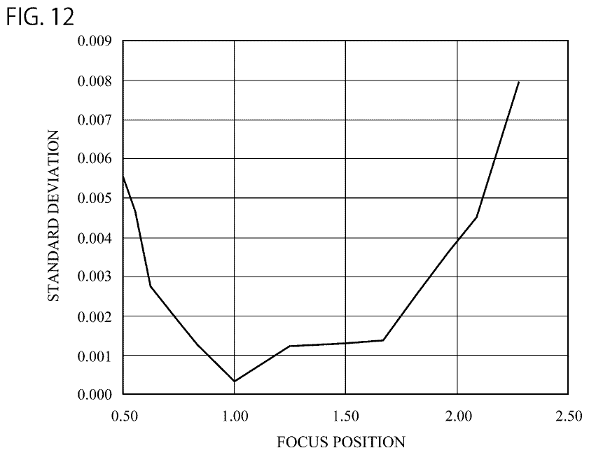

FIG. 12 is a diagram illustrating a relationship between a focus position and a standard deviation of all peak values. As illustrated in FIG. 12, even when the standard deviation of all the peak values is used, a change with respect to the focus position tends to be substantially the same as those in FIGS. 10 and 11. This tendency is considered to be similar even when a standard deviation of a plurality of peak values among the nth largest peak values in the cross-correlation is used. In addition, it is considered that the same tendency is obtained even if dispersion is used instead of the standard deviation. Therefore, even if a difference is calculated by the standard deviation or dispersion of a plurality of peak values among the nth largest peak values in the cross-correlation, a degree of asymmetry can be appropriately obtained.

As described above, the difference calculation step P4B may be another method as long as the difference between the plurality of peak values among the nth largest peaks in the cross-correlation is calculated for each focus position. In the case of another method as well, a difference between a plurality of peak values among the nth largest peaks in the cross-correlation is calculated for each focus position, and a degree of asymmetry is obtained based on the difference, whereby the degree of asymmetry can be appropriately obtained.

As described above, the alignment method of the optical fibers 10A and 10B according to the present embodiment includes: the imaging step P2 of capturing side surface images of the pair of optical fibers 10A and 10B in the circumferential direction for one turn at the plurality of focus positions; the feature amount calculation step P3 of calculating, for each of the focus positions, a feature amount obtained by digitizing features of the side surface images for one turn of the respective optical fibers 10A and 10B; the degree of asymmetry calculation step P4 of calculating, for each of the focus positions, a degree of asymmetry between the feature amounts for one turn of the respective optical fibers 10A and 10B; the focus position selection step P6 of selecting a specific focus position among the focus positions having a predetermined degree of asymmetry or more; and the rotation alignment step P7 of performing alignment of the optical fibers 10A and 10B in the circumferential direction based on the side surface images for one turn of the optical fibers 10A and 10B at the selected focus position.

In addition, the alignment device 200 of the optical fibers 10A and 10B of the present embodiment includes the imaging units 105A and 105B that capture the side surface images of the pair of optical fibers 10A and 10B in the circumferential direction for one turn at the plurality of focus positions, the feature amount calculation unit 112 that calculates, for each of the focus positions, a feature amount obtained by digitizing features of the side surface images for one turn of the optical fibers 10A and 10B, the degree of asymmetry calculation unit 113 that calculates, for each focus position, a degree of asymmetry between the feature amounts for one turn of the optical fibers 10A and 10B, the focus position selection unit 114 that selects a specific focus position among the focus positions having a predetermined degree of asymmetry or more, and the rotation alignment unit that performs alignment of the pair of optical fibers 10A and 10B in the circumferential direction based on the side surface image for one turn of the respective optical fibers 10A and 10B at the selected focus position.

In the alignment method and the alignment device 200, the selected focus position is a position at which the degree of asymmetry between the feature amounts for one turn based on the side surface images for one turn of the pair of optical fibers 10A and 10B is equal to or greater than a predetermined degree of asymmetry. Therefore, the side surface images captured at the selected focus position more clearly show a structural difference between the optical fibers 10A and 10B than the side surface images captured at the focus position having a degree of asymmetry smaller than the predetermined degree of asymmetry. In this manner, the focus position at which the structural difference between the optical fibers 10A and 10B is clear is selected, and alignment is performed using the side surface images in which the structural difference is clear. Therefore, according to the alignment method of the optical fibers 10A and 10B and the alignment device 200 of the present embodiment, it is possible to appropriately perform alignment in the circumferential direction.

In addition, in the alignment method of the present embodiment, the degree of asymmetry calculation step P4 includes the cross-correlation calculation step P4A and the difference calculation step P4B, and when the feature amounts for one turn includes n repetitive patterns of two or more times similar to each other, in the cross-correlation calculation step P4A, the relative angle formed between the optical fibers 10A and 10B in the circumferential direction is changed for each focus position, and the cross-correlation between the feature amounts for one turn of the optical fibers 10A and 10B is calculated at each relative angle. Further, in the difference calculation step P4B, a difference between a plurality of peak values among the nth largest peaks Pk1 to Pkn in the cross-correlation is calculated for each focus position, and a degree of asymmetry is obtained based on the difference. In addition, in the alignment device 200 of the present embodiment, the degree of asymmetry calculation unit 113 includes the cross-correlation calculation unit 113A and the difference calculation unit 113B, and in a case where the feature amount for one turn includes n repetitive patterns of two or more times similar to each other, the cross-correlation calculation unit 113A changes, for each of the focus positions, the relative angle formed between the optical fibers 10A and 10B in the circumferential direction and calculates the cross-correlation between the feature amounts for one turn of the optical fibers 10A and 10B at each relative angle, and the difference calculation unit 113B calculates a difference between a plurality of peak values among the nth largest peaks Pk1 to Pkn in the cross-correlation for each focus position and obtains a degree of asymmetry based on the difference therebetween.

In a case where the feature amount for one turn includes n repetitive patterns of 2 times or more, the respective optical fibers 10A and 10B have refractive index profiles similar to each other in n-fold rotational symmetry in the circumferential direction having the central axis C of the clad 12 as a central portion thereof. In the case of performing alignment of the optical fibers 10A and 10B, when the relative angle formed between the optical fibers 10A and 10B is changed and the cross-correlation between the feature amounts for one turn of the side surface images of the optical fibers 10A and 10B is calculated, large peaks as many as the plurality of repetitive patterns are calculated. This large peak is due to the influence of the refractive index profile forming each pattern. Therefore, a deviation between the nth largest peaks, which are the same as the number of the plurality of repetitive patterns in the cross-correlation, indicates a deviation of the refractive index profile forming each of the repetitive patterns. Therefore, by calculating a difference between a plurality of peak values among the n peaks due to the influence of the refractive index profile and obtaining the degree of asymmetry based on the difference therebetween, the degree of asymmetry can be easily obtained. In the present embodiment, when the degree of asymmetry is obtained, the calculated difference is used as the degree of asymmetry as it is. When the degree of asymmetry is obtained, the degree of asymmetry may be obtained by converting the calculated difference by a predetermined equation.

In addition, the manufacturing method of the optical fiber connector 1 of the present embodiment includes the fusion splicing step P8 of aligning the pair of optical fibers 10A and 10B by the above-described alignment method of the optical fibers 10A and 10B and then fusion-splicing the optical fibers 10A and 10B. In addition, the optical fiber fusion splicing machine 100 according to the present embodiment includes the alignment device 200 for the optical fibers 10A and 10B and the fusion splicing unit 101 that fusion-splices the optical fibers 10A and 10B aligned by the alignment device 200. According to the manufacturing method of the optical fiber connector 1 and the fusion splicing machine, it is possible to obtain the optical fiber connector 1 appropriately aligned in the circumferential direction.

Although the present invention has been described with reference to the above-described embodiments as an example, the present invention is not limited to the above-described embodiments.

For example, in the above embodiment, the example in which the optical fibers 10A and 10B have the four cores 11 has been described. However, in the case of a multicore fiber, the number of cores 11 is not limited to four. In addition, the optical fibers 10A and 10B may include a trench layer having a refractive index lower than the refractive index of the clad 12 so as to surround each core 11.

Additionally, in the above embodiment, the example in which the optical fibers 10A and 10B are multicore fibers has been described. However, the optical fibers 10A and 10B in the above embodiment may have refractive index profiles similar to each other in n-fold rotational symmetry in the circumferential direction having the central axis C of the clad 12 as a central portion thereof. Therefore, for example, the optical fibers 10A and 10B may be a stress applying optical fiber including one core 11 arranged along the central axis C of the clad 12 and further including a pair of stress applying parts so as to sandwich the core 11. In this case, the feature amounts for one turn of the optical fibers 10A and 10B include two repetitive patterns similar to each other are provided.

In the embodiment described above, the degree of asymmetry calculation unit 113 includes the cross-correlation calculation unit 113A and the difference calculation unit 113B, and the degree of asymmetry calculation step P4 includes the cross-correlation calculation step P4A and the difference calculation step P4B. However, as long as a degree of asymmetry between the feature amounts for one turn of the optical fibers 10A and 10B is calculated for each focus position, the degree of asymmetry calculation unit 113 may not include the cross-correlation calculation unit 113A and the difference calculation unit 113B, and the degree of asymmetry calculation step P4 may not include the cross-correlation calculation step P4A and the difference calculation step P4B. For example, in a case where the optical fibers 10A and 10B are optical fibers including the clad 12 and one core 11 arranged along the central axis C of the clad 12, and the cores 11 are unevenly distributed, the optical fibers 10A and 10B do not have refractive index profiles similar to each other in two or more times of rotational symmetry in the circumferential direction having the central axis C of the clad 12 as a central portion thereof. In this case, in the degree of asymmetry calculation step P4, the degree of asymmetry calculation unit 113 may calculate the degree of asymmetry between feature amounts from the feature amounts for one turn of the optical fibers 10A and 10B, for example, for each focus position.

According to the present invention, it is possible to provide an optical fiber alignment method capable of appropriately performing alignment in the circumferential direction, an optical fiber connector manufacturing method using the alignment method, an optical fiber alignment device capable of appropriately performing alignment in the circumferential direction, and an optical fiber fusion splicing machine using the alignment device, and the present invention can be used, for example, in the field of optical communication and the like.

1. An optical fiber alignment method comprising:
an imaging step of capturing side surface images of a pair of optical fibers for one turn in a circumferential direction at a plurality of focus positions;
a feature amount calculation step of calculating, for each of the focus positions, a feature amount for each of the optical fibers for the one turn, the feature amount being obtained by digitizing features of the side surface images;
a degree of asymmetry calculation step of calculating, for each of the focus positions, a degree of asymmetry between the feature amounts for the one turn of the respective optical fibers;
a focus position selection step of selecting a specific focus position among the focus positions having a predetermined degree of asymmetry or more that is larger than a smallest degree of asymmetry; and
a rotation alignment step of performing alignment of the pair of optical fibers in the circumferential direction based on the side surface images for the one turn of the respective optical fibers at the selected focus position.

2. The optical fiber alignment method according to claim 1, wherein:
the degree of asymmetry calculation step includes a cross-correlation calculation step and a difference calculation step, and
when the feature amounts for the one turn include n repetitive patterns of two or more times similar to each other,
in the cross-correlation calculation step, a relative angle formed between the respective optical fibers in the circumferential direction is changed for each of the focus positions, and a cross-correlation between the feature amounts for the one turn of the respective optical fibers is calculated at each relative angle, and
in the difference calculation step, a difference between a plurality of peak values among nth largest peaks in the cross-correlation is calculated for each focus position, and the degree of asymmetry is obtained based on the difference.

3. The optical fiber alignment method according to claim 2, wherein, in the difference calculation step, the difference is calculated by a standard deviation or a dispersion of the plurality of peak values.

4. The optical fiber alignment method according to claim 2, wherein, in the difference calculation step, the difference is calculated by a ratio or a difference between two peak values among the nth largest peak values.

5. The optical fiber alignment method according to any one of claims 1 to 4, wherein, in the focus position selection step, when a standard deviation of all the degrees of asymmetry is set to σ, the focus position having the degree of asymmetry of 1+1.96σ or more is selected.

6. The optical fiber alignment method according to any one of claims 1 to 4, wherein, in the focus position selection step, the focus position having the maximum degree of asymmetry is selected.

7. An optical fiber connector manufacturing method comprising a fusion splicing step of aligning the pair of optical fibers by the optical fiber alignment method according to any one of claims 1 to 6 and then fusion-splicing the pair of optical fibers.

8. An optical fiber alignment device comprising:
an imaging unit configured to capture side surface images of a pair of optical fibers for one turn in a circumferential direction at a plurality of focus positions;
a feature amount calculation unit configured to calculate, for each of the focus positions, a feature amount for each of the optical fibers for the one turn, the feature amount being obtained by digitizing features of the side surface images;
a degree of asymmetry calculation unit configured to calculate, for each of the focus positions, a degree of asymmetry between the feature amounts for the one turn of the respective optical fibers;
a focus position selection unit configured to select a specific focus position among the focus positions having a predetermined degree of asymmetry or more that is larger than a smallest degree of asymmetry; and
a rotation alignment unit configured to perform alignment of the pair of optical fibers in the circumferential direction based on the side surface images for the one turn of the respective optical fibers at the selected focus position.

9. The optical fiber alignment device according to claim 8, wherein:
the degree of asymmetry calculation unit includes a cross-correlation calculation unit and a difference calculation unit, and
when the feature amounts for the one turn includes n repetitive patterns of two or more times similar to each other,
the cross-correlation calculation unit is configured to change, for each of the focus positions, a relative angle formed between the respective optical fibers in the circumferential direction, and to calculate a cross-correlation between the feature amounts for the one turn of the respective optical fibers at each relative angle, and
the difference calculation unit is configured to calculate, for each focus position, a difference between a plurality of peak values among nth largest peaks in the cross-correlation, and to obtain the degree of asymmetry based on the difference.

10. The optical fiber alignment device according to claim 9, wherein the difference calculation unit is configured to calculate the difference by a standard deviation or a dispersion of the plurality of peak values.

11. The optical fiber alignment device according to claim 9, wherein the difference calculation unit is configured to calculate the difference by a ratio or a difference between two peak values among the nth largest peak values.

12. The optical fiber alignment device according to any one of claims 8 to 11, wherein the focus position selection unit is configured to select, when a standard deviation of all the degrees of asymmetry is set to σ, the focus position having the degree of asymmetry of 1+1.96σ or more.

13. The optical fiber alignment device according to any one of claims 8 to 11, wherein the focus position selection unit is configured to select the focus position having the maximum degree of asymmetry.

14. An optical fiber fusion splicing machine comprising:
the optical fiber alignment device according to any one of claims 8 to 13; and
a fusion splicing unit configured to fusion-splice the pair of optical fibers aligned by the alignment device.
